(19) United States
(12) Patent Application Publication
(10) Pub. No.: US 2025/0344194 A1
(43) Pub. Date: Nov. 6, 2025

(54) UE RESOURCE SELECTION IN GRANT-BASED TRANSMISSIONS

(71) Applicant: Huawei Technologies Co., Ltd., Shenzhen (CN)

(72) Inventors: Aman Jassal, Stittsville (CA); Amine Maaref, Ottawa (CA); Jianglei Ma, Ottawa (CA)

(21) Appl. No.: 19/262,866

(22) Filed: Jul. 8, 2025

Related U.S. Application Data
(63) Continuation of application No. PCT/CN2023/071447, filed on Jan. 9, 2023.

(51) Int. Cl. H04W 72/0446; H04W 72/0453; H04W 72/12

(52) U.S. Cl. CPC H04W 72/0446; H04W 72/0453; H04W 72/12

(57) ABSTRACT

In some wireless communication scenarios, a situation may arise in which the propagation delay between the user equipment (UE) and the transmit-and-receive point (TRP) is such that by the time a grant is received by the UE and data is transmitted by the UE according to the grant, the channel conditions have changed. In some embodiments, the UE instead autonomously selects at least one resource for a grant-based data transmission. For example, the UE may select the resource based on channel conditions locally measured by the UE. A method may include a UE receiving a flag and a grant scheduling at least a time resource for data. The flag indicates that the UE is to transmit the data using at least one resource selected by the UE. The UE transmits the data on the time resource using the at least one resource selected by the UE.

### CROSS-REFERENCE TO RELATED APPLICATION

This application is a continuation of International Application No. PCT/CN2023/071447, filed on Jan. 9, 2023, entitled “UE RESOURCE SELECTION IN GRANT-BASED TRANSMISSIONS,” the contents of which are hereby incorporated by reference in their entireties.

### TECHNICAL FIELD

The present application relates to wireless communication, and in particular to grant-based wireless transmissions.

### BACKGROUND

In some wireless communication systems, electronic devices, such as user equipments (UEs), wirelessly communicate with a network via one or more transmit-and-receive points (TRPs). A TRP may be a terrestrial TRP (T-TRP) or non-terrestrial TRP (NT-TRP). An example of a T-TRP is a stationary base station or Node B. An example of an NT-TRP is a TRP that can move through space to relocate, e.g. a TRP mounted on a satellite. The term “TRP”, as used herein, may refer to either a T-TRP or an NT-TRP.

A wireless communication from a UE to a TRP is referred to as an uplink transmission. A wireless communication from a TRP to a UE is referred to as a downlink transmission. Resources are required to perform uplink and downlink transmissions. For example, a UE may wirelessly transmit data, such as a transport block (TB), to a TRP in an uplink transmission over a particular frequency (or range of frequencies) for a particular duration of time. The frequency and time duration are examples of resources, typically referred to as time-frequency resources. Other examples of resources include resources in the spatial domain (e.g. the beam that is used), resources in the power domain (e.g. transmission power), modulation and coding scheme (MCS) used, etc.

Some wireless communication systems implement grant-based transmissions. For example, if a UE wants to transmit data to a TRP, the UE sends a request to the TRP, e.g. a scheduling request (SR). The TRP sends a response to the UE allocating the resources to be used by the UE to transmit the data, e.g. allocating the uplink time-frequency resources and MCS to be used by the UE to transmit the data. The response may be referred to as a grant. Allocating resources in a grant may be referred to as scheduling, which is why the grant is sometimes called a scheduling grant. The grant schedules the resources to be used by the UE to transmit the data. “Grant” and “schedule” may sometimes be used interchangeably.

Link adaptation may be implemented to help the TRP select which resources (e.g. which MCS) the TRP is to allocate to the UE in the grant. A UE may periodically transmit a reference signal, such as a sounding reference signal (SRS), to the TRP. The TRP uses the reference signal to measure the conditions of the uplink channel. The TRP then grants resources in the grant in accordance with the channel conditions. For example, if the uplink channel is poor quality then the MCS value allocated in the grant may be low, resulting in the UE using a low modulation scheme (e.g. QPSK) and low coding rate (e.g. ½) to increase the probability that the UE's transmission will be successfully decoded by the TRP. In implementing link adaptation, the TRP may perform periodic channel estimation to track the channel conditions and try to derive the optimal time-frequency resources and MCS to allocate to the UE when scheduling UE transmissions.

### SUMMARY

The channel conditions change over time. For the purposes of resource selection, the channel is assumed to remain unchanged for a duration of time equal to the coherence time T_{c}. If the TRP receives a sounding reference signal (SRS) from the UE and uses it to measure the uplink channel conditions, those uplink channel conditions are treated as unchanging for the coherence time duration T_{c}. A grant may be sent to the UE allocating resources based on those uplink channel conditions.

However, a situation may arise in which the propagation delay between the UE and TRP is such that by the time the grant is received by the UE and the data is sent by the UE according to the grant, the channel conditions have changed. An example may be a UE communicating with an NT-TRP relatively far away, e.g. a UE communicating with a satellite. The propagation time between the UE and the satellite may be longer than the coherence time of the uplink channel. The situation may be exacerbated if communication occurs over frequency bands that reduce the channel coherence time (e.g. communication over mmWave). In situations in which the propagation time exceeds the channel coherence time, the result is that when a TRP sends the UE a grant scheduling a UE data transmission, the channel conditions will have changed by the time the grant is received by the UE, which means that the resources selected by the TRP and indicated in the grant are outdated by the time the grant is decoded by the UE. Scheduling and link adaptation become out-of-sync relative to the changing channel conditions experienced by the UE. The result may be sub-optimal capacity performance due to this mismatch between the information indicated in the grant and the channel's changing conditions. For example, a low MCS may have been allocated, but the channel conditions are now better and the reduced data throughput associated with a low MCS is no longer needed.

In some embodiments, the UE instead autonomously selects at least one resource for a data transmission (e.g., for a granted data transmission that is granted via a configured grant or a dynamic grant). For example, the resource selected by the UE may be MCS. The UE may select an MCS based on channel conditions locally measured by the UE, and then the UE may use its selected MCS for the granted data transmission. In some embodiments, the UE may transmit an indication of the resource selected by the UE so that the receiving device knows which resource to use for receiving the data. In some embodiments, the grant (e.g., the configured grant or the dynamic grant) may omit the field for indicating a resource selected by the UE, e.g. if the UE is to autonomously select the MCS, then the grant might not indicate the MCS. In some embodiments, the UE receives a flag indicating that the UE is to transmit the data in the granted data transmission using the at least one resource selected by the UE. For example, the flag may be carried in the grant, e.g. the flag may be a bit in DCI explicitly indicating that the UE can select the resource, and/or the flag may be implicit, e.g. the receipt of a particular DCI format associated with UE resource selection may act as the flag.

In some embodiments, a method performed by an apparatus (e.g. UE) includes receiving a flag and a grant scheduling at least a time resource for data. The flag indicates that the apparatus is to transmit the data using at least one resource selected by the apparatus. The method further includes transmitting the data on the time resource using the at least one resource selected by the apparatus. In some embodiments, the at least one resource selected by the apparatus includes at least one of: a modulation, a coding rate, a coding type, an MCS, a frequency resource, a transmit power, a beam, a precoding, or a number of precoding layers. In some embodiments, the apparatus selects the at least one resource based on a channel condition determined by the apparatus. In some embodiments, the apparatus transmits the indication of the at least one resource so that the receiving device knows which resource(s) was used by the apparatus.

In some embodiments, a corresponding method performed by a device (e.g. a TRP) includes transmitting, to an apparatus, a flag and a grant scheduling at least a time resource for data. The flag indicates that the apparatus is to transmit the data using at least one resource selected by the apparatus. The method may further include receiving the data on the time resource using the at least one resource selected by the apparatus. The at least one resource selected by the apparatus may include at least one of: a modulation, a coding rate, a coding type, an MCS, a frequency resource, a transmit power, a beam, a precoding, or a number of precoding layers.

Technical benefits of some embodiments include addressing the impact of propagation delays on link adaptation and scheduling for wireless communication by having a UE select one or more resources, e.g. MCS, for the granted data transmission. Link capacity may possibly be improved because one or more resources used by the UE to transmit the granted data transmission (e.g. the MCS of the UE's transmission) may be matched to the instantaneous or near-instantaneous channel conditions measured by the UE, rather than relying on a stale/out-of-date resource allocated in the grant.

Corresponding apparatuses and devices for performing the methods herein are also disclosed. For example, the apparatus comprising means for implementing the method at the UE side shown above. The apparatus may be the UE. The apparatus may be a component/module/chipset of the UE. The device comprising means for implementing the method at the network side shown above. The device may be the NT-TRP or T-TRP. The device may be a component/module/chipset of the NT-TRP or T-TRP.

Further, there is provided a non-transitory computer readable storage medium, wherein the non-transitory computer readable storage medium stores computer-executable instructions, and when the instructions are executed by a computer, the computer performs the method at the UE side or the method at the network side.

Further, there is provided a communication system comprising at least one device implementing the method at the network side and at least one apparatus implementing the method at the UE side.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates a user equipment (UE) communicating with an NT-TRP, according to some embodiments;

FIG. 6 illustrates a device transmitting a flag and grant to an apparatus, according to some embodiments;

FIG. 7 illustrates the apparatus and device, according to some embodiments;

FIG. 8 illustrates a method performed by the apparatus and device, according to some embodiments;

FIG. 9 illustrates an example of control information carrying an indication;

FIG. 10 illustrates an example of the indication transmitted on time-frequency resources scheduled for the data;

FIG. 11 illustrates denoted parameters related to multiplexing the indication with the data;

FIG. 12 illustrates an example of the indication transmitted in a control channel separate from time-frequency resources scheduled for the data;

FIG. 13 illustrates example configuration messages;

FIG. 14 illustrates examples of an enhanced scheduling request (SR);

FIG. 15 illustrates an example of a grant in the form of an enhanced SR response; and

FIG. 16 carries the example of FIG. 15 to a specific uplink scenario.

### DETAILED DESCRIPTION

For illustrative purposes, specific example embodiments will now be explained in greater detail below in conjunction with the figures.

### Example Communication Systems and Devices

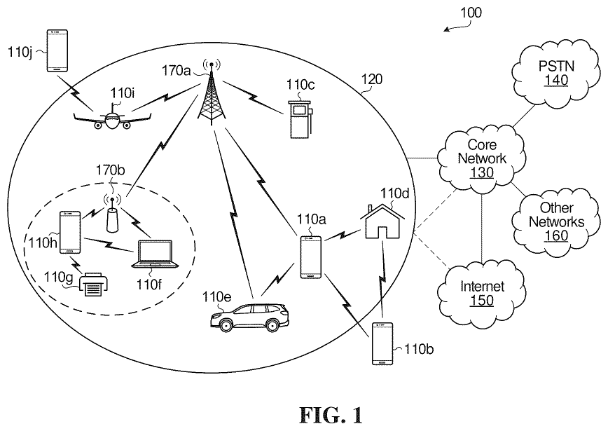

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

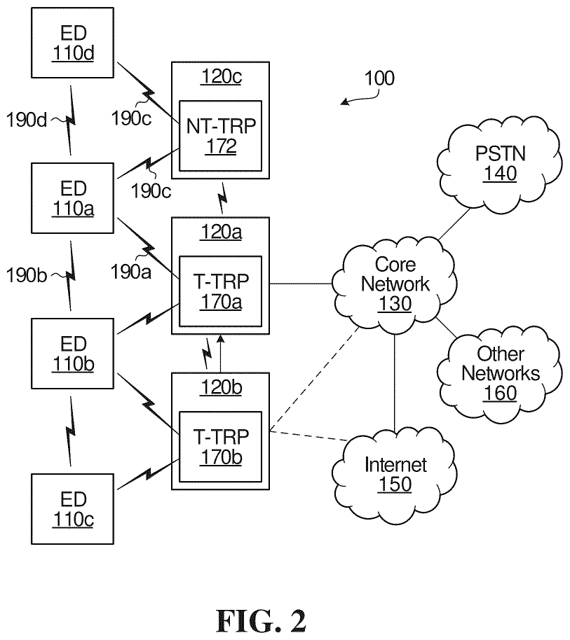

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

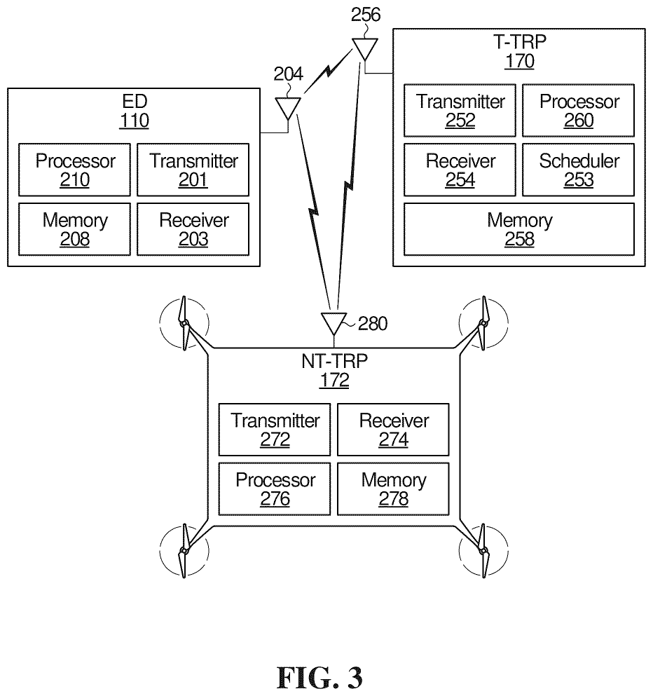

FIG. 3 illustrates another example of an ED 110, a base station 170 (e.g. 170a, and/or 170b), which will be referred to as a T-TRP 170, and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 11o may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, sidelink, and/or backhaul transmissions, including issuing scheduling grants (“dynamic grant”) and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or an NT-TRP.

The T-TRP 170, the NT-TRP 172, and/or the ED 110 may include other components, but these have been omitted for the sake of clarity.

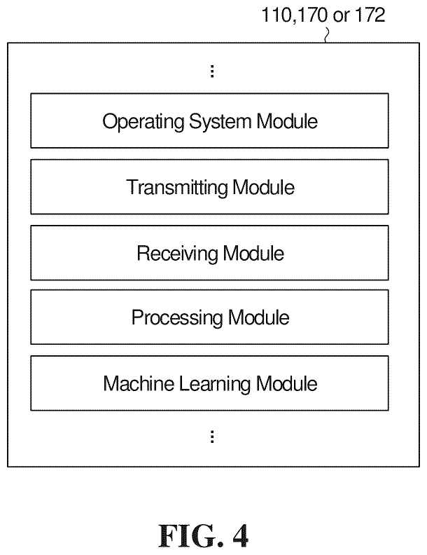

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 11o, T-TRP 170, and NT-TRP 172 are known to those of skill in the art. As such, these details are omitted here.

Control information is discussed herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH, downlink control information (DCI) sent in a PDCCH, or sidelink control information (SCI) sent in a physical sidelink control channel (PSCCH). A dynamic indication may be an indication in lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling such as RRC signaling and/or a MAC CE. Dynamic signaling, as used herein, may refer to signaling that is dynamic, e.g. physical layer control signaling sent in the physical layer, such as DCI sent in a PDCCH, UCI sent in a PUCCH, or SCI sent in a PSCCH.

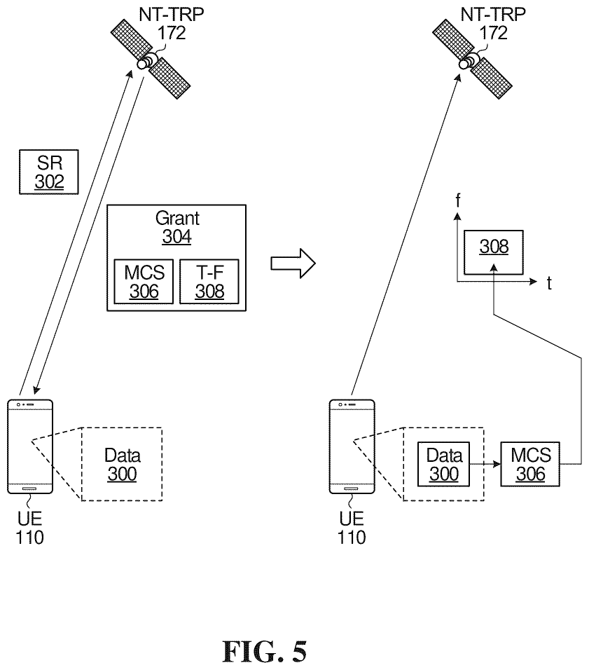

FIG. 5 illustrates ED 110 in the form of a UE 110 communicating with NT-TRP 172, according to some embodiments. In the example illustrated in FIG. 5, the UE 110 is a mobile device and the NT-TRP 172 is a satellite. The UE 110 has uplink data 300 to transmit to the NT-TRP 172, and so the UE 110 transmits a scheduling request (SR) 302, e.g. as part of control information in an uplink control channel. The uplink control channel may be a physical uplink control channel (PUCCH). In response, the NT-TRP 172 sends a grant 304, e.g. an uplink grant because it grants resources for an uplink data transmission. The grant 304 allocates the resources to be used by the UE 110 to transmit the data 300. The allocated resources include the MCS 306 to be used by the UE 110 to transmit the data 300 and the time-frequency resources 308 to be used by the UE 110 to transmit the data 300. The grant 304 may allocate other resources, e.g. transmit power, which have not been illustrated. The granted time-frequency resources 308 may be allocated in a data channel, such as in a physical uplink shared channel (PUSCH).

The UE 110 subsequently transmits the uplink data 300 to the NT-TRP 172 using the MCS 306 on the granted time-frequency resources 308. The MCS 306, and possibly other allocated resources, are selected by the network based on the measured uplink channel conditions, e.g. which may be measured using a sounding reference signal (SRS) transmitted by the UE 110 to the NT-TRP 172. For example, if the measured uplink channel conditions are poor, then a lower MCS may be allocated to the uplink transmission, which increases the robustness of the transmission at the expense of reducing data throughput.

However, the propagation time between the UE 110 and the NT-TRP 172 may be longer than the coherence time of the uplink channel, such that by the time the UE 110 is to transmit the granted uplink transmission, the allocated resources can no longer be assumed to match the channel conditions. For example, a low MCS may have been allocated, but the channel conditions are now improved such that the low MCS is no longer necessary. In some embodiments herein, the UE 110 may instead autonomously select one or more of the resources use to transmit the granted transmission, e.g. the UE 110 may locally determine the channel conditions of the uplink channel just prior to sending the granted transmission and select a suitable MCS, and then indicate the selected MCS to the NT-TRP 172.

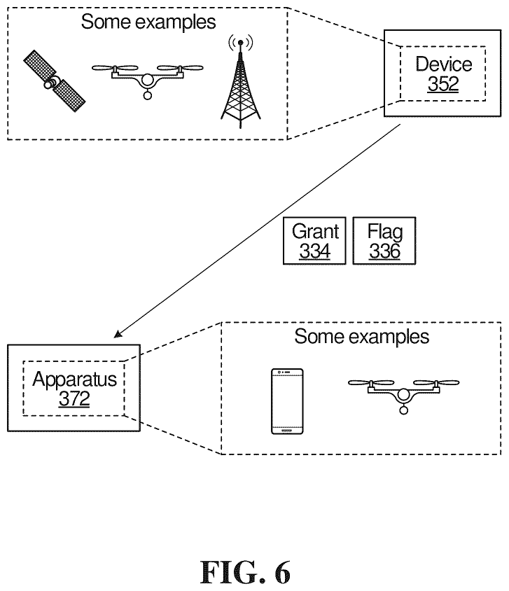

The embodiments described herein are not limited to a UE communicating with an NT-TRP far away (e.g. a satellite), as is the case in the example in FIG. 5. The two devices do not necessarily even need to be far away if the coherence time of the channel is short, e.g. as may be the case at certain transmission frequencies. Also, the granted transmission does not necessarily have to be “uplink”, e.g. there could be a granted sidelink or backhaul transmission where autonomous selection of one or more resources by the transmitting apparatus may be performed. For example, in a sidelink scenario a first UE may be granted time-frequency resources to communicate with a second UE in the sidelink, and the first UE may autonomously select at least one resource (e.g. MCS) for the granted transmission based on the sidelink channel conditions measured by the first UE. Also, the grant does not necessarily need to be in response to a scheduling request, e.g. if it is known by the network that there is, should be, or may be data that needs to be transmitted. Therefore, more generally, FIG. 6 illustrates a device 352 transmitting a grant 334 to an apparatus 372, according to some embodiments. The terms “apparatus” and “device” are used to distinguish between the two entities. Their implementation depends upon the application scenario. A few examples are illustrated in FIG. 6. The apparatus 372 might be a UE or a drone, for example. Depending upon the implementation, a drone might be considered a UE. In some embodiments, the apparatus 372 may be a UE in the form of a consumer device, such as a terminal, phone, vehicle, wearable, tablet, etc. In some embodiments, the apparatus 372 may support radio access technologies such as 5G new radio (NR), 6G systems, and/or non-terrestrial communication systems. For example, the apparatus 372 may have the capability to communicate with a satellite and/or a high-altitude platform system (HAPS). In some embodiments, the device 352 might be a satellite, a HAPS device, a drone, or base station (e.g. a “super” base station). These are only examples.

The grant 334 schedules a transmission of data from the apparatus 372. The grant 334 schedules at least a time resource for the data. The grant 334 may be sent in dynamic signaling such as DCI, or in higher-layer signaling such as RRC signaling or a MAC CE. The device 352 also transmits a flag 336 to the apparatus 372. The flag 336 indicates that the apparatus 372 is to transmit the data in the granted data transmission using at least one resource selected by the apparatus 372. The flag 336 and grant 334 may be in a same message or in separate messages. If the flag 336 and grant 334 are in the same message, the flag 336 may be explicit (e.g. a bit) or it may be implicit (e.g. the grant 334 has a certain format that acts as the flag). If the flag 336 and grant 334 are in different messages, they may be carried in the same type of signaling (e.g. both the grant and flag may be carried in RRC signaling) or in different types of signaling (e.g. the flag may be carried in RRC signaling or a MAC CE, and the grant may be carried in DCI).

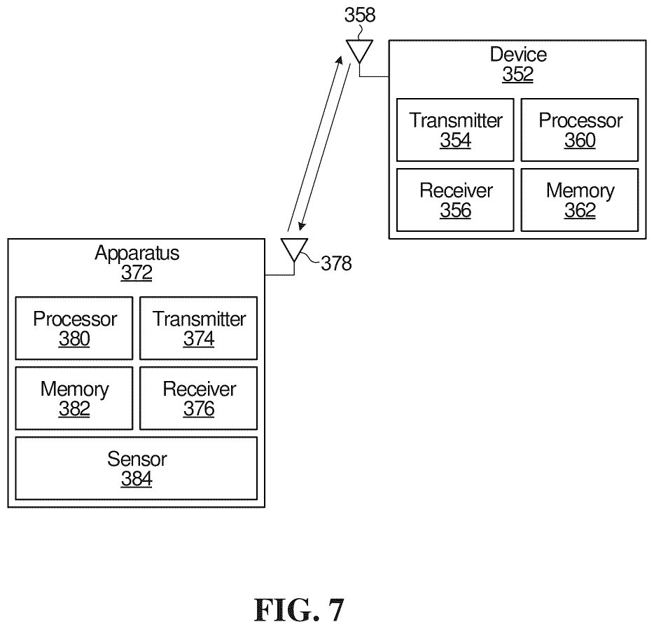

FIG. 7 illustrates the device 352 and apparatus 372, according to some embodiments.

The device 352 may be a TRP, such as a T-TRP 170 or NT-TRP 172, for example. The device 352 may be part of the network (e.g. acting as an access point to the network) and may be a network device. In some embodiments, the parts of the device 352 may be distributed. For example, some of the modules of the device 352 may be located remote from the equipment housing the antennas and/or panels of the device 352, and may be coupled to the equipment housing the antennas/panels over a communication link (not shown). Therefore, in some embodiments, the term device 352 may also or instead refer to one or more modules (e.g. an integrated circuit) on the network side that perform processing operations, such as resource allocation (e.g. generating grants), message generation, encoding/decoding, etc., and that are not necessarily part of the equipment housing the antennas and/or panels of the device 352. For example, the modules that are not necessarily part of the equipment housing the antennas/panels of the device 352 may include one or more modules that: decode a scheduling request, and/or generate a grant allocating resources, and/or generate a flag, and/or demodulate and decode data received from the apparatus 372 in a granted transmission. The modules may also be coupled to other devices. In some embodiments, the device 352 may actually be a plurality of devices (e.g. a plurality of TRPs) that are operating together to serve apparatus 372, e.g. through coordinated multipoint transmissions.

The device 352 includes a transmitter 354 and receiver 356, which may be integrated as a transceiver. The transmitter 354 and receiver 356 are coupled to one or more antennas 358. Only one antenna 358 is illustrated. One, some, or all of the antennas may alternatively be panels. The processor 360 of the device 352 performs (or controls the device 352 to perform) much of the operations described herein as being performed by the device 352, e.g. receiving and decoding a scheduling request, generating a grant allocating resources, generating a flag, demodulating and decoding data received from the apparatus 372 in a granted transmission, etc. Generation of information (e.g. data and/or control information) for transmission may include arranging the information in a message format, encoding the message, modulating, performing beamforming (as necessary), etc. Processing received transmissions may include performing beamforming (as necessary), demodulating and decoding the received messages, etc. Demodulating may be performed by a demodulator, which may be implemented by the processor 360, possibly together with the decoder. The demodulator performs demodulation in accordance with a modulation scheme that has been used to transmit the data. For example, if quadrature amplitude modulation (QAM) was used to modulate the signal, then demodulation may be performed using a coherent demodulator, e.g. splitting the signal and applying each to a mixer, with one half having the in-phase local oscillator applied and the other half having the quadrature oscillator signal applied. Decoding may be performed by a decoding method that decodes according to a channel coding scheme, e.g. polar decoding if the data and/or control information is encoded using a polar code, low-density parity check (LDPC) decoding algorithm for a LDPC code, etc. Example decoding methods that may be implemented include (but are not limited to): maximum likelihood (ML) decoding, and/or minimum distance decoding, and/or syndrome decoding, and/or Viterbi decoding, etc.

Although not illustrated, the processor 360 may form part of the transmitter 354 and/or receiver 356. The device 352 further includes a memory 362 for storing information (e.g. control information and/or data).

The processor 360 and processing components of the transmitter 354 and receiver 356 may be implemented by the same or different one or more processors that are configured to execute instructions stored in a memory (e.g. in memory 362). Alternatively, some or all of the processor 360 and/or processing components of the transmitter 354 and/or receiver 356 may be implemented using dedicated circuitry, such as a programmed FPGA, a GPU, or an ASIC.

If the device 352 is T-TRP 170, then the transmitter 354 may be or include transmitter 252, the receiver 356 may be or include receiver 254, the processor 360 may be or include processor 260 and may implement scheduler 253, and the memory 362 may be or include memory 258. If the device 352 is NT-TRP 172, then the transmitter 354 may be or include transmitter 272, the receiver 356 may be or include receiver 274, the processor 360 may be or include processor 276, and the memory 362 may be or include memory 278.

The apparatus 372 includes a transmitter 374 and receiver 376, which may be integrated as a transceiver. The transmitter 374 and receiver 376 are coupled to one or more antennas 378. Only one antenna 378 is illustrated. One, some, or all of the antennas may alternatively be panels. The processor 380 of the apparatus 372 performs (or controls the apparatus 372 to perform) much of the operations described herein as being performed by the apparatus 372, e.g. transmitting the scheduling request, receiving and decoding the grant and flag, determining channel conditions, autonomously selecting a resource (e.g. modulation and/or coding rate) for a granted data transmission, etc. Generation of information (e.g. data and/or control information) for transmission may include arranging the information in a message format, encoding the message, modulating, performing beamforming (as necessary), etc. Encoding may be performed by an encoder (which may be implemented by processor 380 possibly in conjunction with a modulator). The encoding is implemented according to a channel coding scheme, e.g. polar coding, LDPC coding, turbo coding, convolutional coding, etc. Modulating is performed by a modulator according to a modulation scheme, e.g. BPSK, QPSK, QAM-16, QAM-64, etc. Processing received transmissions may include performing beamforming (as necessary), demodulating and decoding the received messages, etc. Examples of ways to demodulate and decode are discussed earlier.

Although not illustrated, the processor 380 may form part of the transmitter 374 and/or receiver 376. The apparatus 372 further includes a memory 382 for storing information (e.g. control information and/or data).

The processor 380 and processing components of the transmitter 374 and receiver 376 may be implemented by the same or different one or more processors that are configured to execute instructions stored in a memory (e.g. in memory 382). Alternatively, some or all of the processor 380 and/or processing components of the transmitter 374 and/or receiver 376 may be implemented using dedicated circuitry, such as a programmed FPGA, a GPU, or an ASIC.

If the apparatus is a UE or other ED 110, then the transmitter 374 may be or include transmitter 201, the receiver 376 may be or include receiver 203, the processor 380 may be or include processor 210, and the memory 382 may be or include memory 208. If the apparatus 372 is an NT-TRP 172 (e.g. a drone), then the transmitter 374 may be or include transmitter 272, the receiver 376 may be or include receiver 274, the processor 380 may be or include processor 276, and the memory 382 may be or include memory 278.

In some embodiments the apparatus 372 includes a sensor 384. Sensor 384 is a device or module whose purpose is to perform sensing, e.g. to detect events or changes in its environment. The implementation of the sensor 384 is application-specific and depends upon the object and/or condition being sensed. In some embodiments, the sensor 384 may be used for radio frequency (RF) sensing, in which case the sensor 384 might be or include an antenna. For example, the sensor 384 may sense electromagnetic waves reflected from at least one object. An example of electromagnetic waves is radio waves. The apparatus 372 may sense its environment using sensor 384, e.g. using radio wave measurements (e.g. radar), and/or acoustic measurements (echolocation), and/or detecting Wi-Fi signals, and/or lidar measurements, etc. The sensing may indicate that certain directions are clear, and other directions have obstructions. For example, the apparatus 372 may transmit one or more radio waves, e.g. radar, and receive a reflection back in some directions. The directions in which reflections are received are determined to be directions that are obstructed and thereby not line-of-sight (LOS). The apparatus 372 may then perform receive and/or transmit beamforming in a direction determined to not have an obstruction.

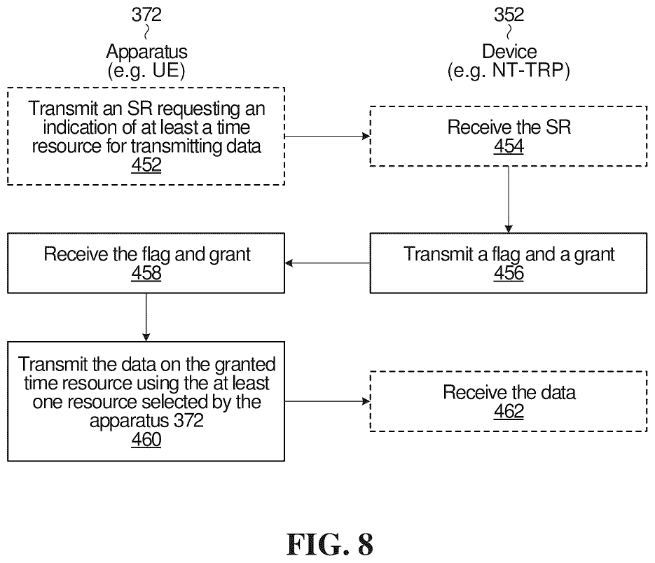

FIG. 8 illustrates a method performed by apparatus 372 and device 352, according to some embodiments.

At step 452, the apparatus 372 transmits a scheduling request (SR) to the device 352. The SR is sent because the apparatus 372 has data to transmit and the apparatus 372 would like a grant of one or more resources to transmit the data. In the illustrated embodiment, the apparatus 372 would like at least a grant of a time resource for transmitting the data. At step 454, the device 352 receives the SR.

Steps 452 and 454 are optional, which is why they are illustrated using a box with stippled lines. The reason steps 452 and 454 are optional is because in some scenarios the apparatus 372 might not need to transmit a SR, e.g. if the device 352 knows by other means that the apparatus 372 has data to transmit. In some scenarios, the network might know that the apparatus 372 will (or should) have data to transmit at certain points or windows in time, and a grant may be sent without the need for an SR.

At step 456 the device 352 transmits, to the apparatus 372, a flag and a grant. The grant schedules at least a time resource for the data, e.g. the time resource granted may be or include a starting time or starting slot for transmitting the data. The flag indicates that the apparatus 372 is to transmit the data in the granted data transmission using at least one resource selected by the apparatus 372. The apparatus 372 does not select the time resource because that is granted. However, the apparatus 372 may select one or more other resources for transmitting the data. At step 458, the apparatus 372 receives the flag and grant.

At step 460, the apparatus 372 then transmits the data on the time resource using the at least one resource selected by the apparatus 372. The at least one resource is “autonomously” selected by the apparatus 372, i.e. it is selected by the apparatus 372 independent of an indication of the resource from the device 352, e.g. either the resource is not indicated by the device 352 (e.g. there is no indication of the resource in the grant), or if it is indicated by the device 352 the indication is ignored. In some embodiments, the at least one resource selected by the apparatus 372 may include at least one of:
A modulation, i.e. the modulation used to modulate the data. In some embodiments, a modulation type may be selected by the apparatus 372, e.g. the apparatus 372 may select between pulse-amplitude modulation (PAM), quadrature amplitude modulation (QAM), frequency-shift keying (FSK), etc. In other embodiments, the modulation type may be predefined or preconfigured and the modulation order may be selected by the apparatus, e.g. the apparatus 372 may select between 4-QAM, 16-QAM, and 64-QAM.
A coding type, i.e. the type of error control code used. For example, the apparatus 372 may select between polar coding, LDPC coding, turbo coding, convolutional coding, etc.
A coding rate. In some embodiments, the coding type might be predefined (e.g. preconfigured), but the rate of the code may be selected by the apparatus 372.
An MCS. In some embodiments, there may be a table of MCS values from which the apparatus 372 can select from, e.g. with each MCS value mapping to a predefined (e.g. preconfigured) modulation and coding. The apparatus 372 selects one of the MCS values and modulates and codes the data according to the MCS value.
A frequency resource, i.e. the frequency resource used to transmit the data. For example, the apparatus 372 may select a particular physical resource block (PRB) or PRBs in the frequency domain on which to transmit the data.
A transmit power, i.e. the power used to transmit the data.
Abeam, e.g. a beam direction. For example, the apparatus 372 may select transmission control information (TCI) corresponding to a particular beam.
A precoding. For example, the apparatus 372 may select a MIMO precoding matrix to be used to transmit the data.
A number of precoding layers used for the precoding.

One, some, or all of the above resources may be selected by the apparatus 372, depending upon the implementation.

A resource that is not selected by the apparatus 372 is either indicated in the grant or is predefined (e.g. fixed or preconfigured). The flag may indicate which resource(s) is/are to be selected by the apparatus 372. As an example, the flag may indicate that the apparatus is to select MCS, i.e. transmit the data using an MCS selected by the apparatus 372. The grant may indicate the other resources needed for the granted transmission, e.g. the time-frequency resources.

At step 462, the device receives the data. Step 462 is optional, which is why it is illustrated using a box with stippled lines. The reason step 462 is optional is because it might not be the device 352 that receives the data, e.g. the granted data transmission may be a transmission of the data to another device or apparatus, e.g. over a sidelink.

The receiving device (e.g. device 352 in step 462 of FIG. 8) receives the data on the time resource using the at least one resource selected by the apparatus 372. The data transmission has the at least one resource, and the apparatus 372 receives the data accordingly. For example, if a particular frequency resource was selected by the apparatus 372, then the device 352 receives the data at that particular frequency resource. In some cases, receiving the data “using” the at least one resource selected by the apparatus 372 means performing an operation in accordance with or based on the selected resource(s). For example, if a particular modulation is selected by the apparatus 372, the device 352 demodulates in accordance with that particular modulation, e.g. if 16-QAM modulation is selected then 16-QAM demodulation is performed. As another example, if a particular coding rate was selected by the apparatus 372, the device decodes in accordance with that coding rate. As another example, if a particular MCS value was selected by the apparatus 372, the device performs demodulation and decoding in accordance with that MCS value.

In some embodiments, the method of FIG. 8 includes the apparatus 372 selecting the at least one resource based on a channel condition determined by the apparatus 372.

Example ways for the apparatus 372 to determine a channel condition of the channel on which the data transmission is to be sent are as follows. In one example, the apparatus 372 uses a received signal, such as a received reference signal or received synchronization signal. For example, the apparatus 372 may use a CSI reference signal (CSI-RS) or other downlink reference signal received by the apparatus 372 from the device 352. The received signal is used by the apparatus 372 to perform a measurement and thereby obtain a measurement result representing the determined channel condition. The measurement result may be a channel measurement result, e.g. of channel quality. Examples of possible measurements include: measuring CSI, such as information related to scattering, fading, power decay and/or signal-to-noise ratio (SNR) in the channel; and/or measuring signal-to-interference-plus-noise ratio (SINR), which is sometimes instead called signal-to-noise-plus-interference ratio (SNIR); and/or measuring Reference Signal Receive Power (RSRP); and/or measuring Reference Signal Receive Quality (RSRQ); and/or measuring channel quality, e.g. to obtain a channel quality indicator (CQI). Performing a measurement on a received signal may include extracting waveform parameters from the signal, such as (but not limited to) amplitude, frequency, noise and/or timing of the waveform. The result may be the measurement. The result of the measurement is referred to as the measurement result, e.g. the measurement result may be the measured SNR, SINR, RRSP, and/or RSRQ. The measurement result represents a channel condition on the receive link, i.e. the opposite direction of the transmit direction on which the data will be transmitted. For example, the apparatus 372 may be sending the data transmission in the uplink, but the channel measurement is that of the downlink. However, the apparatus 372 assumes that the channel conditions on the link are substantially the same in both directions, e.g. a channel condition determined by the apparatus 372 in the downlink is substantially the same as the channel condition in the uplink. Therefore, for example, a reference signal received by the apparatus 372 shortly before sending the data transmission may be used by the apparatus 372 to estimate the channel condition for transmitting the data. The determined channel condition may be mapped to a particular resource to select, e.g. via a look up table. For example, the measured channel conditions may map to different possible MCS values that may be selected by the apparatus 372. In some embodiments, the apparatus 372 may use artificial intelligence (AI)/machine learning (ML) to determine a channel condition, e.g. based on a variety of inputs that are implementation specific. The output of the AI/ML model may be an indication of the channel condition and/or an indication of what the channel condition will be x ms into the future. The output might not be an explicit indication of a channel condition but may be a value that inherently indicates a channel condition, e.g. the output of the AI/ML model may be a predicted MCS to be used by the apparatus 372. The value of the MCS is an indirect indication of the channel condition, and the MCS may be said to be based on the determined channel condition, even though the AI/ML model may not literally output a value that is a measurement of the channel condition. In some embodiments, a combination of channel measurements (e.g. of the downlink channel) and AI/ML may be used to select the resource. For example, an input to a trained ML model may include the measurement of the channel on the receive link (e.g. on the downlink), and the output of the trained ML model may be an MCS value to be selected by the apparatus 372. In some embodiments, sensing may be used in determining the channel measurements, e.g. the sensor 384 of the apparatus 372 may use a camera and/or radio waves and/or another method to determine what directions are clear and what directions are obstructed, which may be used to determine the channel conditions, possibly in conjunction with AI/ML (e.g. the sensing measurements may be an input to the trained ML model).

In some embodiments, the channel condition may be measured by the apparatus 372 prior to (e.g. just prior to) transmitting the data in step 460. Because the channel condition is measured by the apparatus 372 prior to and relatively close to the time at which the apparatus 372 is to transmit the data, the measured channel condition is not stale. The resource selected by the apparatus 372 (e.g. the selected MCS) has a better match. In some embodiments, the channel condition is measured by the apparatus 372 less than T_{c} ms prior to transmitting the data, where T_{c} is the coherence time of the channel. In some embodiments, the channel condition is measured by the apparatus 372 immediately prior to transmitting the data.

In one example, the apparatus 372 selects which MCS to use based on a channel condition measured by the apparatus 372. The channel condition may be measured prior to (e.g. just prior to) transmitting the data in step 460. If the channel condition indicates that the channel is low quality, then a low MCS is selected by the apparatus 372 to transmit the data in the granted transmission, whereas if the channel condition indicates that the channel is high quality, then a high MCS is selected by the apparatus 372 to transmit the data in the granted transmission. Because the channel condition is measured by the apparatus 372 prior to and relatively close to the time at which the apparatus 372 is to transmit the granted transmission, the measured channel condition is not stale. The MCS has a better match.

In some embodiments, the method of FIG. 8 includes the apparatus 372 transmitting an indication of the at least one resource selected by the apparatus 372. This allows the receiving device (e.g. device 352 in step 462) to know the resource selected by the apparatus 372 so that the receiving device can receive the data using that resource. For example, if the apparatus 372 selects a particular MCS value and modulates and codes in accordance with that MCS value, then the apparatus 372 may provide an indication of that MCS value to the receiving device so that the receiving device can demodulate and decode the data according to the MCS value.

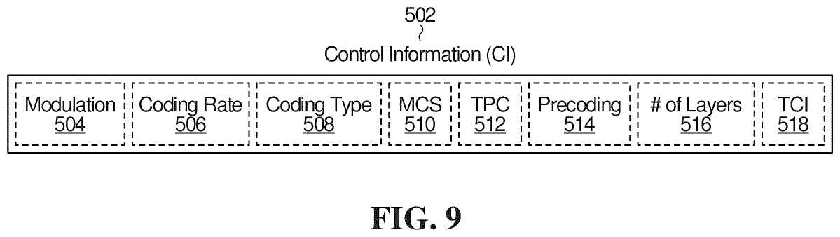

The indication may be sent in control information. One example of such control information transmitted by the apparatus 372 is illustrated in FIG. 9. The control information (CI) 502 may be transmitted as part of step 460 of the method of FIG. 9.

If a modulation was selected by the apparatus 372, then the CI 502 may include a field 504 indicating the modulation used by the apparatus 372 to modulate the data in the granted transmission. As one example, the field 504 may be two bits long and signal one of four different possible modulation choices by the apparatus 372: BPSK, QPSK, 16-QAM, or 64-QAM. As another example, the field 504 may indicate one of different possible modulation schemes selected by the apparatus (e.g. PAM vs. QAM). In some embodiments, the modulation choices (e.g. schemes and/or orders) may be preconfigured in advance, e.g. using higher-layer signaling, with the field 504 indicating one of the possible preconfigured options.

If a coding rate was selected by the apparatus 372, then the CI 502 may include a field 506 indicating the code rate used by the apparatus 372 to encode the bits of the data in the granted transmission. As one example, the field 506 may be four bits long and signal one of 16 possible different coding rates. In some embodiments, the code rate choices may be preconfigured in advance, e.g. using higher-layer signaling, with the field 506 indicating one of the possible preconfigured options.

If a coding type was selected by the apparatus 372, then the CI 502 may include a field 508 indicating the coding type used by the apparatus 372 to encode the bits of the data in the granted transmission. As one example, the field 508 may be two bits long and signal one of four different possible coding type choices by the apparatus 372: polar coding, LDPC coding, turbo coding, or convolutional coding. In some embodiments, the code type choices may be preconfigured in advance, e.g. using higher-layer signaling, with the field 508 indicating one of the possible preconfigured options.

If an MCS value was selected by the apparatus 372, the CI 502 may include a field 510 indicating the MCS value, which indicates which modulation and coding was performed on the data by the apparatus 372. The MCS value may, for example, be selected from a table of MCS values, such as a look-up-table (LUT) of MCS values that is known to both the apparatus 372 and device 352. If the MCS field 510 is present in the CI 502, then the modulation field 504, coding rate field 506, and coding type field 508 may be omitted. In some embodiments, a set of MCS values may be preconfigured in advance, e.g. using higher-layer signaling, with the field 510 indicating one of the possible preconfigured options.

If the apparatus 372 selects the transmit power control (TPC) used by the apparatus 372 to transmit the data in the granted transmission, then the control CI 502 may include a field 512 indicating the selected TPC. As an example, the field 512 may be four bits and indicate one of 16 possible transmit powers. In some embodiments, a set of transmit power values may be preconfigured in advance, e.g. using higher-layer signaling, with the field 512 indicating one of the possible preconfigured options.

If the precoding (e.g. MIMO precoding matrix) is selected by the apparatus 372, then the CI 502 may include a field 514 indicating the selected precoding. As an example, the field 514 may be five bits and indicate one of 32 possible options. In some embodiments, a set of precoding matrices may be preconfigured in advance, e.g. using higher-layer signaling, with the field 514 indicating one of the possible preconfigured options.

If the number of layers (e.g. number of MIMO layers) is selected by the apparatus 372, then the CI 502 may include a field 516 indicating the selected number of layers. As an example, the field 516 may be two bits and indicate one of four possible options. In some embodiments, the options for number of layers may be preconfigured in advance, e.g. using higher-layer signaling, with the field 516 indicating one of the possible preconfigured options.

If the transmit control information (TCI) is selected by the apparatus 372, then the CI 502 may include a field 518 indicating the selected TCI. As an example, the field 518 may be three bits and indicate one of eight possible options. In some embodiments, a set of TCI (e.g. beam) values may be preconfigured in advance, e.g. using higher-layer signaling, with the field 518 indicating one of the possible preconfigured options.

In some embodiments, the CI 502 may possibly include reserved or spare bits (not illustrated), depending upon the implementation.

Not all of the illustrated fields are necessarily included in the CI 502. For example, if a particular resource is not selected by the apparatus 372, then it does not need to be indicated in the CI 502. As an example, if the MCS is the only resource selected by the apparatus 372, then the CI 502 might only include the MCS field 510 and none of the other illustrated fields.

Also, not every resource selected by the apparatus 372 is necessarily indicated in the CI 502. For example, one or more resources selected by the apparatus 372 may be indicated in a SR. For example, a frequency resource selected by the apparatus 372 may be indicated in the SR so that the receiving device knows the frequency resources on which to receive the transmission. If any of the resources selected by the apparatus 372 are already known by the receiving device (e.g. they were indicated in a SR), then they do not need to be indicated in CI 502.

Note that it is not necessary to transmit CI 502 in all implementations. For example, there might be an implementation in which the one or more resources selected by the apparatus 372 are not indicated and the receiving device performs blind detection/decoding.

In some embodiments, CI 502 is an information element. In some embodiments, the format (e.g. location and length of fields) of the CI 502 may be defined by higher-layer signaling, such as RRC signaling. In some embodiments, the CI 502 has an MCS that is predefined, e.g. preconfigured in advance using higher-layer signaling such as RRC signaling, or dynamically indicated (e.g. in DCI and/or in an enhanced SR response). This allows for the device 352 to demodulate and decode the CI 502.

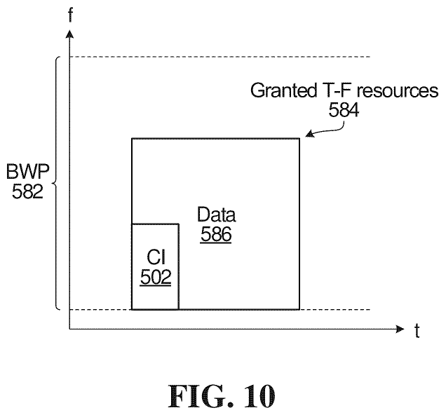

In some embodiments, the indication (e.g. CI 502) may be transmitted on time-frequency resources scheduled for the data, e.g. the indication may be multiplexed with the data. An example is illustrated in FIG. 10 in which the indication is carried in CI 502. In the example, the apparatus 372 is configured with frequency resources, e.g. bandwidth part (BWP) 582, for communicating with the device 352. RRC signaling may have been used to configure the BWP 582. The apparatus 372 is granted time-frequency resources 584 for transmitting data 586, e.g. in the grant sent in step 456 and received in step 458 of FIG. 8. In the example, the apparatus 372 selects the MCS for transmitting the data 586. A modulating and coding corresponding to the selected MCS is applied to the data 586 transmitted in step 460 of FIG. 8. The CI 502 indicates the selected MCS.

The apparatus 372 not only uses the granted time-frequency resources 584 to transmit the data 586, but also to transmit the CI 502 indicating the MCS used by the apparatus 372 to modulate and code the data 586. In operation, the CI 502 itself is transmitted with an MCS that is predefined, e.g. an MCS that is fixed or preconfigured (e.g. using RRC signaling) so that it is known in advance by both the apparatus 372 and the device 352. The device 352 first demodulates and decodes the CI 502 to obtain the content (e.g. payload) of the CI 502. The content of the CI 502 includes an indication of the MCS that was used by the apparatus 372 to modulate and code the data 586. The device 352 then uses that indicated MCS to demodulate and decode the data 586. For example, if the MCS was indicated in the CI 502 as being a value corresponding to 16-QAM and 0.5 code rate, then the device 352 applies a corresponding 16-QAM demodulation of the data 586 and a corresponding decoding of the demodulated data bits in accordance with a 0.5 code rate encoding scheme. The CI 502 therefore allows for the device 352 to be provided with an indication of the MCS of the data 586, so that the device 352 does not have to blindly demodulate and decode the data 586 without knowledge of the MCS. In embodiments in which the granted data transmission is an uplink transmission and the CI 502 is sent on the time-frequency resources granted for the data transmission, the CI 502 may be referred to as “PUSCH Control Information (PUSCH-CI)”.

When the indication (e.g. CI 502) is transmitted on time-frequency resources scheduled for the data, then the indication may be multiplexed with the data. Continuing with the example of FIG. 10, the bits of the CI 502 may be mapped on resource elements (REs) included in the granted time-frequency resources 584 scheduled for the data 586. In some embodiments, the bits of the CI 502 are mapped on the REs at a predefined (e.g. preconfigured or fixed) location so that the device 352 knows their location in the time-frequency resources 584. For example, the bits of the CI 502 may be always mapped in increasing order of frequency-domain subcarrier followed by increasing order of time-domain OFDM symbol, starting from the lowest subcarrier of the first PRB of the first OFDM symbol. After having decoded the REs on which the CI 502 is transmitted, the device 352 can use the information in the CI 502 to decode the data 586 mapped on the remainder of the REs in the granted time-frequency resources 584. One specific example of multiplexing is as follows.

In the specific example, the granted data transmission will be assumed to be a granted uplink transmission, and the CI 502 will be referred to as PUSCH-CI. The bits of the PUSCH-CI are channel coded by the apparatus 372 using a predefined coding scheme/rate, e.g. polar coding or LDPC coding or turbo coding or convolutional coding, and modulated with a predefined modulation denoted as

$${Q}_{m}^{PUSCH - CI} , where {Q}_{m}^{PUSCH - CI}$$

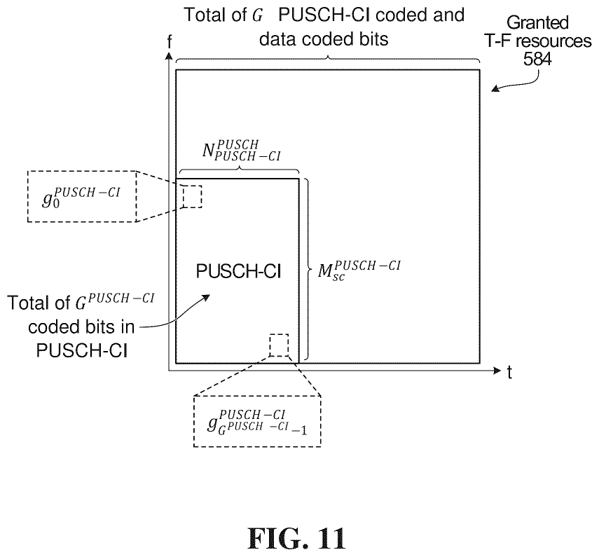

may be (for example) BPSK or QPSK or QAM-16 or QAM-64. With reference to FIG. 11, the bitstream of PUSCH-CI coded bits generated by the apparatus 372 is denoted as

$${g}_{0}^{PUSCH - CI} , {g}_{1}^{PUSCH - CI} , … , {g}_{{G}^{PUSCH - CI} - 1}^{PUSCH - CI} ,$$

where G^{PUSCH-CI} is the total number of PUSCH-CI coded bits. The PUSCH-CI coded bits are to be mapped to the control and data multiplexed bitstream of coded bits. The control and data multiplexed bitstream of coded bits is denoted as g₀, g₁, . . . , g_{G-1}, where G is the total number of PUSCH-CI coded and data coded bits. The PUSCH-CI coded bits are mapped on individual REs (i.e. a given OFDM symbol and a given subcarrier) which are reserved for mapping the PUSCH-CI bitstream.

$${N}_{PUSCH - CI}^{PUSCH}$$

is denoted as the number of OFDM symbols reserved for PUSCH-CI and

$${M}_{s c}^{PUSCH - CI}$$

is denoted as the number of subcarriers reserved for PUSCH-CI, such that the total number of reserved REs is

$${N}_{PUSCH - CI}^{PUSCH} \times {M}_{sc}^{P U S C H - CI} .$$

The multiplexing algorithm first determines the number of REs required to map the PUSCH-CI bits on. The multiplexing algorithm allocates REs from the set of REs for the PUSCH-CI and these REs are then removed from the set of REs for the uplink shared channel (UL SCH) bits. The PUSCH-CI coded bits are mapped on REs reserved for them. The PUSCH-CI bits are modulated using their own modulation

$${Q}_{m}^{PUSCH - CI} .$$

The PUSCH-CI coded bits are appended to the multiplexed bitstream and the control+data multiplexed bitstream is generated.

In some embodiments, the number of reserved REs on which the PUSCH-CI is mapped, denoted as

$${N}_{PUSCH - CI}^{PUSCH} \times {M}_{sc}^{PUSCH - CI} ,$$

may depend on the number of REs allocated for the PUSCH transmission, which may be denoted as

$${N}_{symb , all}^{PUSCH} \times {M}_{s c}^{PUSCH} .$$

However, due to additional overhead caused by the presence of uplink reference signals (e.g. PUSCH-DMRSs) and the presence of the PUSCH-CI, there may be additional processing complexity at the apparatus 372 in terms of rate-matching, where rate-matching is the operation where the apparatus 372 adjusts the effective code rate to the desired code-rate. The effective code-rate may be derived as:

$${CR}_{PUSCH} = ( {N}_{TB} + {N}_{CRC} ) / ( {Q}_{m}^{PUSCH} \cdot {N}_{symb , all}^{PUSCH} \times {M}_{s c}^{PUSCH} ) ,$$

where CR_{PUSCH} is the effective code-rate of the PUSCH, N_{TB} is the number of coded bits in the Transport Block, and N_{CRC} is the number of bits in the CRC. However, the presence of the PUSCH reduces the total number of REs for the PUSCH, thus resulting in increasing the effective code-rate, and the new effective code rate can be derived as:

$${CR}_{PUSCH} = ( {N}_{TB} + {N}_{CRC} ) / ( {Q}_{m}^{PUSCH} \cdot ( {N}_{symb , all}^{PUSCH} \cdot {M}_{sc}^{PUSCH - CI} - {N}_{symb , all}^{PUSCH} \cdot {M}_{sc}^{PUSCH} ) ) .$$

Due to implementation complexity in LDCP/Polar-coding encoders, it might not be possible to arbitrarily implement new effective code-rates, which may constrain the number of REs occupied by the PUSCH-CI.

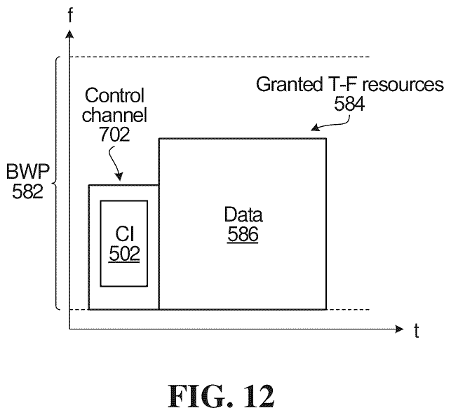

In some embodiments, the indication (e.g. CI 502) may instead be transmitted in a control channel separate from time-frequency resources scheduled for the data. An example is illustrated in FIG. 12 in which the indication is carried in CI 502. In the example, the apparatus 372 is configured with frequency resources, e.g. bandwidth part (BWP) 582, for communicating with the device 352. RRC signaling may have been used to configure the BWP 582. The apparatus 372 is granted time-frequency resources 584 for transmitting data 586, e.g. in the grant sent in step 456 and received in step 458 of FIG. 8. The apparatus 372 is also configured with a control channel 702 for transmitting the CI 502 related to the granted data transmission. The control channel 702 is a region of time-frequency resources different from the region of time-frequency resources on which the data 586 is scheduled. For example, in the illustrated embodiment the control channel 702 is located immediately prior to where the time-frequency resources 584 are located for the granted data transmission. However, more generally there may be a gap in time and/or frequency between where the control channel 702 is located and where a data transmission may be scheduled. In some embodiments, the time-frequency region of the control channel 702 may be defined via higher-layer signaling (such as via RRC signaling), e.g. the control channel 702 may be periodically recurring in time with one or more regions for scheduling data interposed between adjacent control channel regions. In the example, the apparatus 372 selects the MCS for transmitting the data 586. The apparatus 372 transmits the CI 502 in the control channel 702. The CI 502 indicates the MCS used by the apparatus 372 to modulate and code the data 586. The CI 502 itself is transmitted in the control channel 702 with an MCS that is predefined, e.g. an MCS that is fixed or preconfigured (e.g. using RRC signaling) so that it is known in advance by both the apparatus 372 and the device 352. The device 352 first demodulates and decodes the CI 502 in the control channel to obtain the content (e.g. payload) of the CI 502. The content of the CI 502 includes an indication of the MCS that was used by the apparatus 372 to modulate and code the data 586. The device 352 then uses that indicated MCS to demodulate and decode the data 586 on time-frequency resources 584. The CI 502 therefore allows for the device 352 to be provided with an indication of the MCS of the data 586, so that the device 352 does not have to blindly demodulate and decode the data 586 without knowledge of the MCS. In embodiments in which the granted data transmission is an uplink transmission and a separate control channel 702 is used to transmit the CI 502, the control channel 702 may be referred to as a “physical uplink information channel (PUICH)” and CI 502 may be referred to as a “PUSCH information control block (PICB)”.

When the indication (e.g. CI 502) is transmitted in a separate control channel, like in FIG. 12, then it may be easier to implement autonomous selection of frequency resources by the apparatus 372 for the granted data transmission. This is because the control channel has a time-frequency location known by the device 352, and the device 352 can first decode that control channel to obtain the CI 502 and extract from the CI 502 the indication of the frequency resources used by the apparatus 372 to transmit the granted data transmission. In contrast, in the embodiment in FIG. 10, there is no separate control channel at a time-frequency location known to the device 352, and so the device 352 would need to blindly try to locate the frequency location of the time-frequency region 584.

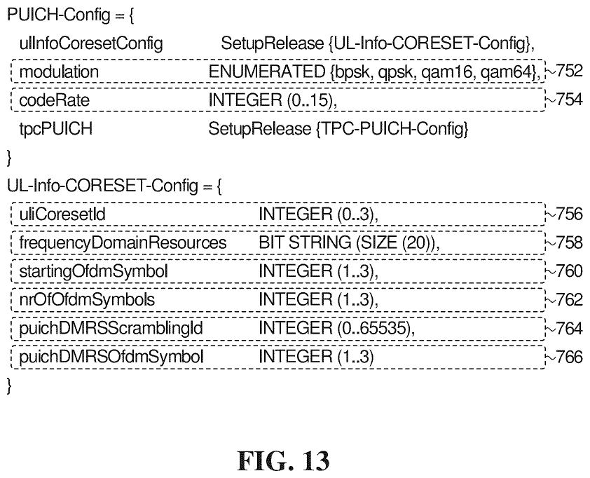

One specific example of the embodiment explained in relation to FIG. 12 is as follows. The granted data transmission will be assumed to be a granted uplink transmission, and the CI 502 will be referred to as PICB. The bits of the PICB are channel coded by the apparatus 372 using a predefined coding scheme/rate, e.g. polar coding or LDPC coding or turbo coding or convolutional coding, and modulated with a predefined modulation, e.g. BPSK or QPSK or QAM-16 or QAM-64. The MCS used for the PICB is predefined (e.g. preconfigured or fixed) and may be configured using higher-layer signaling (e.g. RRC signaling). The coded bits of the PICB are mapped to the REs of an Uplink Information Control Resource Set (ULI-CORESET), which is located in control channel 702. In an example, the coded bits of the PICB are always mapped on the REs in the ULI-CORESET in increasing order of frequency-domain subcarrier followed by increasing order of time-domain OFDM symbol, starting from the lowest subcarrier of the first PRB of the first OFDM symbol. In the example, the PICB indicates the MCS used by the apparatus 372 to modulate and code the bits of the data 586. After having decoded the PICB, the device 352 can obtain the indication of that MCS and then proceed with demodulating and decoding the coded bits of the data 586 on the PUSCH REs of time-frequency resources 584. The ULI-CORESET may be configured by the network using higher-layer signaling, such as RRC signaling. One example of a configuration is as follows. The control channel 702 is configured via a “PUICH-Config” message, e.g. which may have the contents illustrated in FIG. 13. As shown at 752, the modulation to be used when transmitting CI 502 on the control channel 702 can be set as one of four modulations by the network: BPSK, QPSK, QAM-16, or QAM-64. As shown at 754, the coding rate to be used when transmitting CI 502 on the control channel 702 can be set as one of 16 different coding rates. The ULI-CORESET may then be configured via a “UL-Info-CORESET-Config” message, e.g. which may have the contents also illustrated in FIG. 13. The ULI-CORESET higher-layer configuration includes a field called ‘uliCoresetId’ 756, which corresponds to the identity of the ULI-CORESET. The ULI-CORESET higher-layer configuration may also include a field called ‘frequencyDomainResources’ 758, which corresponds to the frequency PRBs occupied by ULI-CORESET within the UL BWP. The ULI-CORESET higher-layer configuration may also include a field called ‘startingOfdmSymbol’ 760, which corresponds to the starting OFDM symbols occupied by the ULI-CORESET within a given slot, where ‘1’ corresponds to the first OFDM symbol of a given slot. The ULI-CORESET higher-layer configuration may also include a field called ‘nrOfOfdmSymbols’ 762, which corresponds to the number of OFDM symbols occupied by the ULI-CORESET within a given slot. The ULI-CORESET higher-layer configuration may also include a field called ‘puichDMRSScramblingId’ 764, which corresponds to the scrambling identity used by the apparatus 372 to initialize the sequence of the PUICH DM-RS. The ULI-CORESET higher-layer configuration may also include a field called ‘puichDMRSOfdmSymbol’ 766, which corresponds to the OFDM symbol in which the PUICH DM-RS is transmitted.

In some embodiments, regardless of whether the CI 502 is transmitted in the time-frequency resources granted for the data transmission (like in FIG. 1) or in a separate control channel (like in FIG. 12), the apparatus 372 may also implement the following processing chain for the CI 502: (1) Attach the Cyclic Redundancy Check and perform RNTI masking (e.g. apply the Exclusive-OR binary operation between the RNTI of the apparatus 372 and the CRC); (2) perform interleaving on the CI 502+CRC bits in order to randomize the sequence, e.g. according to a predefined interleaving pattern; (3) Apply channel coding on the interleaved bits according to a predefined channel coding scheme (e.g. using polar coding, or LDPC Coding, or turbo coding, or convolutional coding, or BCH coding, etc.); (4) Perform Rate Matching in order to select to be transmitted; (5) Perform Scrambling by using a common or apparatus-specific (e.g. UE-specific) RNTI to randomize the bit stream; (6) Apply modulation according to the predefined modulation scheme to transform the coded bitstream into a complex-modulated symbol-stream; (7) Map the complex-modulated symbols on the applicable Resource Elements (REs). In an embodiment in which the CI 502 is multiplexed in with the data transmission (like in FIG. 10), the multiplexing is performed as part of the processing chain, e.g. between steps (3) and (4). In some embodiments, the processing chain described above may be performed just prior to step 460 of FIG. 8.

Returning to FIG. 8, in some embodiments the method of FIG. 8 may include the apparatus 372 transmitting an SR in step 452 and the device 352 receiving the SR in step 454. The SR requests a grant for data to be transmitted from the apparatus 372, e.g. at least a grant of a time resource. If steps 452 and 454 are implemented, then in some embodiments the SR may be transmitted in uplink control information (UCI), e.g. in a PUCCH. In some embodiments, the SR includes a request that the apparatus 372 select the at least one resource for the data transmission that is granted. For example, in some embodiments the SR may carry a bit field indicating that the SR is not a conventional SR, but is one in which the apparatus 372 wants to autonomously select the at least one resource for the granted transmission. Such a SR may be called an “enhanced SR”, and it my carry a bit field (e.g. named “enhanced”), which (for example), if set to the value ‘1’ indicates that the SR is an enhanced SR. The indication that it is an enhanced SR indicates to the device 352 that the apparatus 372 wants to autonomously select the at least one resource for the transmission to be granted by the device 352.

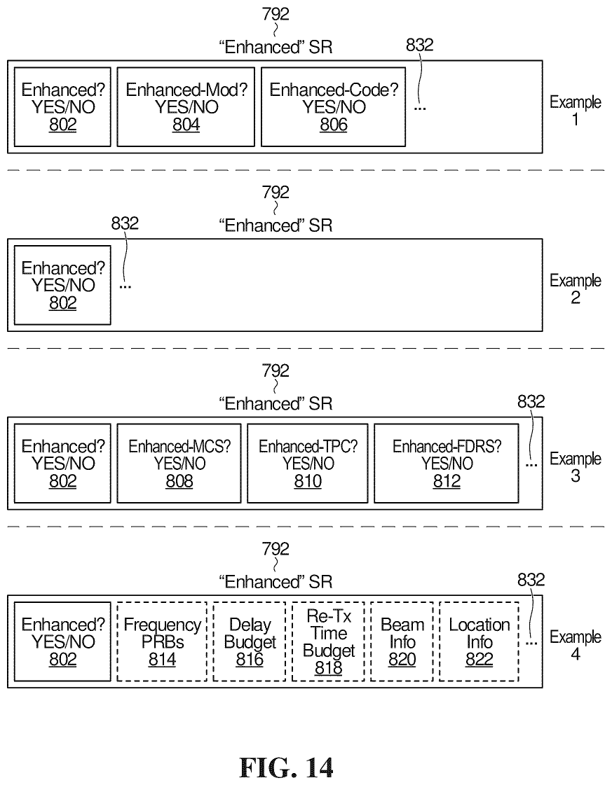

Four examples of an enhanced SR are illustrated in FIG. 14. These are all examples of an SR that may be transmitted in step 452 of FIG. 8. In Example 1, the SR 792 includes a bit field 802 indicating whether or not the SR 792 is enhanced. If set to ‘1’ (“yes”), the SR 792 includes two additional bit fields: bit field 804 indicating whether or not the apparatus 372 wants to autonomously select its own modulation scheme for the granted transmission, and bit field 806 indicating whether or not the apparatus 372 wants to autonomously select its own coding rate for the granted transmission. If either field 804 or 806 is set to ‘1’ (“yes”), then the device 352 does not need to allocate and indicate that resource in the grant sent in step 456 of FIG. 8.

In Example 2 of FIG. 14, if the bit field 802 is set to ‘1’ (“yes”) indicating that the SR is enhanced, this also acts as an indication that the apparatus 372 wants to autonomously select its own MCS for the granted transmission. Therefore, fields 804 and 806 do not need to be included.

In Example 3 of FIG. 14, the apparatus 372 may request to autonomously select other resources besides resources related to modulation and/or coding. Assuming field 802 is set to ‘1’ (“yes”), i.e. the SR is enhanced, then field 808 indicates whether or not the apparatus 372 wants to autonomously select its own MCS for transmitting the granted transmission. Field 810 indicates whether or not the apparatus 372 wants to autonomously perform its own transmit power control (TPC) (i.e. autonomously select its own transmit power) for transmitting the granted transmission. Field 812 indicates whether or not the apparatus wants to autonomously perform its own frequency domain resource selection (FDRS), i.e. whether the apparatus wants to autonomously select its own frequency resources (e.g. physical resource blocks (PRBs)) for the granted transmission. However, autonomous selection of the frequency resources may possibly occur in the SR request itself (e.g. via field 814 described below in Example 4) so that the device 352 knows in advance the frequency resources on which to look for the granted transmission, to avoid a situation of the apparatus 372 autonomously selecting the frequency domain resources just prior to sending the granted transmission, then transmitting on those frequency resources, and the device 352 not knowing which frequency resources to find the transmission.

The SR 792 in Example 3 might include additional or different fields indicating, to the device 352, other resources that the apparatus 372 wants to autonomously select for the granted data transmission. For example, the SR 792 may include a field indicating whether or not the apparatus 372 wants to select transmission control information (TCI), e.g. beam direction. As another example, the SR 792 may include a field indicating whether or not precoding information wants to be selected by the apparatus 372. As another example, the SR 792 may include a field indicating whether or not the number of layers (e.g. for a MIMO transmission) wants to be selected by the apparatus 372.

Note that fields 802, 804, 806, 808, 810, and 812 do not autonomously select the resource, but simply indicate to the device 352 that in the data transmission sent by the apparatus 372 in response to the grant (e.g. in the data transmission of step 460 of FIG. 8), the apparatus 372 requests to select the resource. Therefore, the fields 802, 804, 806, 808, 810, and 812 might each only be one bit, to indicate “yes” or “no”. In some such cases, it would be premature for the apparatus 372 to select and indicate a resource in the SR because the channel conditions will change by the time the granted transmission is to be sent. Instead, in such instances the apparatus 372 selects the resource based on the channel conditions closer to when the granted transmission is to be sent and indicates the selected resource at that time, e.g. in CI 502.

Example 4 of FIG. 14 illustrates that an enhanced SR may additionally include one or more optional fields that provide information to the device 352. Optional field 814 allows the apparatus 372 to indicate, to the device 352, which frequency resources are to be used for the granted data transmission, e.g. by indicating the PRBs using N1 bits. The PRBs may be indicated using a PRB bitmap. The field 814 might act as an autonomous selection of the frequency resources, by the apparatus 372, for the granted transmission. Alternatively, field 814 might instead act as a request, e.g. the device 352 still ultimately schedules the frequency resources for the transmission, and the device 352 might or might not use the frequency resources indicated in field 814. The field 814 might only apply to a first transmission granted by the device 352 in response to the SR. Alternatively the field 814 might apply to a series of transmissions granted by the device 352 (e.g. over time) in response to the SR. Field 814 may be included in the SR on the premise that the device 352 may have too hard of a time performing detection/decoding if the frequency resources for the granted transmission are not indicated in advance of the granted transmission. If field 814 is included in the SR, then it might not be necessary to include field 812 in the SR.

Optional field 816 allows the apparatus 372 to indicate, to the device 352, how delay tolerant the data is for which the apparatus 372 is requesting a transmission grant. This may help the device 352 decide how soon the device 352 should schedule the transmission of the data. As an example, field 816 may include N2 bits that indicate one of five different delay tolerances/time budgets associated with the data: 20 ms, 40 ms, 60 ms, 80 ms, or looms. Depending upon the implementation, the device 352 might or might not be obliged to schedule the transmission of the data in accordance with the delay tolerance indicated in field 816.

Optional field 818 allows the apparatus 372 to indicate, to the device 352, a time budget for sending a retransmission of a data packet scheduled for transmission but incorrectly decoded by the device 352. As an example, field 818 may include N3 bits that indicate one of four different time budgets for retransmission: 8 ms, 10 ms, 12 ms, or 16 ms. Depending upon the implementation, the device 352 might or might not be obliged to schedule any required retransmission of data packets of the data in accordance with the time budget indicated in field 818.

Optional field 820 allows the apparatus 372 to indicate, to the device 352, a beam angle on which the granted transmission is to be sent from the apparatus 372. As an example, field 820 may include N4 bits that indicate an azimuth angle and a zenith angle. The angle indicated in field 820 may indicate the angular direction in which the apparatus 372 will align its transmission spatial filter (i.e. its transmit beam). Depending upon the implementation, the device 352 might or might not be obliged to use the beam angle indicated in field 820.

Optional field 822 allows the apparatus 372 to indicate, to the device 352, a geographic location of the apparatus 372. This may assist the device 352 in scheduling the transmission, e.g. the device 352 may schedule the transmission on a particular beam based on the location of the apparatus 372. In some embodiments, field 822 may be N5 bits long and may indicate a latitude and a longitude.

Although not illustrated in Example 4 of FIG. 14, in some embodiments the enhanced SR 792 may include a field indicating a recommended modulation and/or coding rate (e.g. a recommended MCS value) to be used for the granted data transmission. The grant may indicate this recommended MCS value, or another MCS value selected by the network.

Variations of the examples described in FIG. 14 are possible. For example, the SR 792 shown in Example 3 might have fields 804 and 806 instead of single field 808 to allow for selection of one of modulation or coding rate and not necessarily both. As another example, the SR 792 shown in Example 3 might only have one of field 810 or 812. As another example, one, some, or all of the optional information fields shown in Example 4 may be in Examples 1 to 3. As another example, bit field 802 may be omitted, e.g. every SR may be “enhanced” by default in that it includes one or more fields for the apparatus 372 to indicate whether the apparatus 372 wants to autonomously select one or more resources. If all such fields are set to ‘no’, then all resources are scheduled by the device 352 in the conventional way.

Although not shown in FIG. 14, each SR 792 may include additional information, e.g. that is typically included in a SR. This is indicated by the three dots 832.

In some embodiments, the enhanced SR, e.g. the examples shown in FIG. 14, may include more bits than known convention SRs. In other embodiments, the enhance SR may have the same number of bits (e.g. by using reserved fields in a conventional SR). In some embodiments, there may be multiple SR UCI formats, possibly of the same total bit length, one of which being the enhanced SR.

In some embodiments, the device 352 may be able to deny or ignore the indication in the enhanced SR requesting that the apparatus 372 select a particular resource. For example, the device 352 might not send a flag indicating that the resource can be selected by the apparatus (e.g. in step 456 of FIG. 8) and instead the device 352 may indicate the resource in the grant.

In some embodiments, the SR may apply to just a single or first transmission granted by the device 352, e.g. a single transmission to be granted to send the data that the apparatus 372 has to send to the device 352. In other embodiments, the SR may relate to requesting the grant of multiple transmissions, in which case the autonomous selection of at least one resource by the apparatus 372 may apply to each of those multiple transmissions. The apparatus 372 may select different ones of the resource or different resources (e.g. different MCS values) for different ones of the granted data transmissions, e.g. depending upon the channel condition measured by the apparatus 372.

In view of the above, in some embodiments of the method of FIG. 8 the method includes step 452 of the apparatus 372 transmitting an SR (and step 454 of the device receiving the SR), where the SR includes a request that the apparatus 372 select at least one resource for the data. Examples of the request are illustrated in FIG. 14, e.g. the request may be in the form of one or more bit values present in one some or all of fields 802, 804, 806, 808, 810, and 812. For example, the request for the apparatus 372 to autonomously select the MCS for the data in the granted data transmission may be a bit value of ‘1’ (“yes”) in field 808, or in the case of Example 2 of FIG. 14 it may be a bit value of ‘1’ (“yes”) in field 802. In some embodiments of FIG. 8 in which an SR is transmitted by the apparatus 372, the SR may additionally or instead include an indication of at least one of: a frequency resource for the data (e.g. field 814 in FIG. 14), a delay tolerance associated with the data (e.g. field 816 in FIG. 14), a time budget associated with retransmission of the data (e.g. field 818 in FIG. 14), a beam angle for transmission of the data (e.g. field 820 in FIG. 14), or a geographic location of the apparatus (e.g. field 822 in FIG. 14).

In some embodiments, responsive to the device 352 receiving an SR at step 454 of FIG. 8, the device 352 performs step 456, i.e. transmits a grant scheduling the data for transmission from the apparatus 372 and transmits the flag indicating that the apparatus 372 is to transmit the data in the granted data transmission using at least one resource selected by the apparatus 372. In some embodiments, the grant may be in control information, which may be higher-layer signaling (e.g. in RRC signaling or MAC CE) or in dynamic signaling (e.g. in DCI, such as in a PDCCH). In some embodiments, the grant schedules at least a time resource for the granted data transmission. In some embodiments, the grant schedules a time-frequency resource for the data, i.e. both a location in time and a location in frequency (e.g. PRBs) at which the data is to be transmitted from the apparatus 372 in step 460. In some embodiments, additional or different resources may be scheduled in the grant, e.g. transmit power and/or beam angle, etc.

In some embodiments, the grant omits a field for indicating the at least one resource selected by the apparatus 372. For example, if the apparatus 372 selects MCS (e.g. if field 808 in the SR 792 is set to “yes”), then the grant does not indicate the MCS.

In some embodiments, if the grant transmitted in step 456 of FIG. 8 is in response to a SR, the grant may be referred to as a SR response. In some embodiments, the SR response may be referred to as an “enhanced” SR response when it indicates that the apparatus 372 has permission to autonomously select the at least one resource. For example, the SR may be that shown in Example 2 of FIG. 14 and include field 502 set to ‘1’ (“yes”) indicating that the apparatus 372 wishes to select the MCS for the granted data transmission. In response, the grant may be an enhanced SR response with a bit field (flag) set to “yes”, which indicates that the request by the apparatus 372 to select MCS has been granted, i.e. the apparatus 372 has permission to select the MCS used to transmit the data in step 460 of FIG. 8. In some embodiments, the enhanced SR response may be called an enhanced grant or (in the context of granting an uplink transmission) an enhanced uplink grant. In some embodiments, the apparatus 372 may expect the device 352 to transmit the enhanced SR response within a certain time interval e.g. at least T symbols and at most T+D symbols after the last symbol of the control information (e.g. UCI in a PUCCH) carrying the enhanced SR.

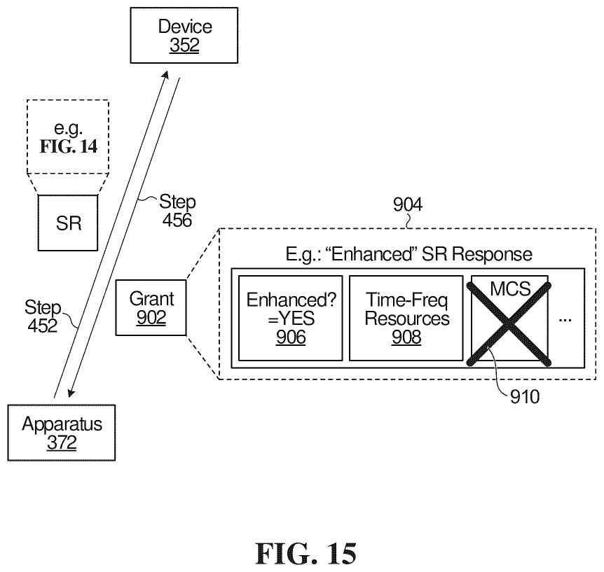

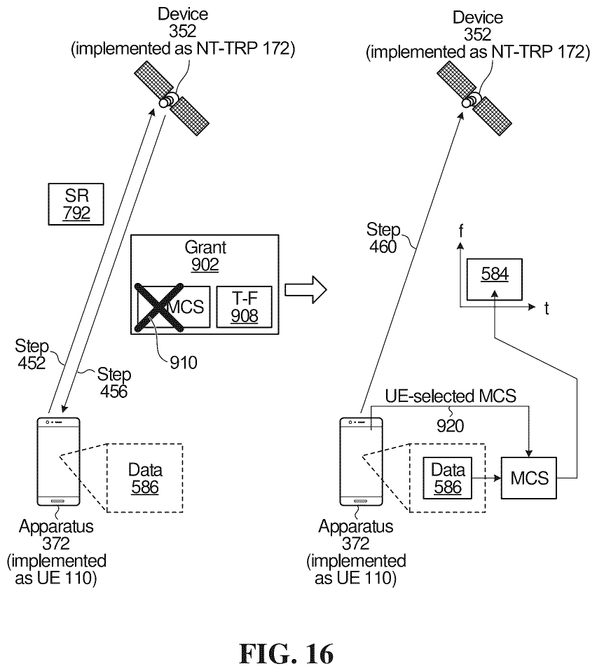

FIG. 16 illustrates one example of a grant 902 sent by the device 352. The grant 902 is sent in step 456 of FIG. 8 and is illustrated in more detail in stippled box 904. In the example, the grant 902 is an enhanced SR response or enhanced transmission grant. It includes a field 906 (e.g. a bit) indicating that the SR response is enhanced. The field 906 may be the flag referenced in step 456 of FIG. 8 Other fields in the enhanced SR response indicate (i.e. allocate) resources to be used by the apparatus 372 to send the data transmission, e.g. the enhanced SR response includes a field 908 indicating the time-frequency resources 584 to be used by the apparatus 372 to transmit the data. In the example, the apparatus 372 has previously requested in the SR that the apparatus 372 autonomously select the MCS for the data in the granted transmission. Therefore, the enhanced SR response in FIG. 15 does not allocate MCS, which is symbolically shown in FIG. 15 by the presence of “X” at 910. For example, the bits normally allocating MCS may be set to zero, or the enhanced SR response may have a format such that there are no bits available for allocating MCS. FIG. 16 carries the example of FIG. 15 to a specific uplink scenario of a UE 110 wanting to send an uplink transmission of data 586 to an NT-TRP 172, which in the illustrated example is a satellite. The UE 110 transmits a SR 792, e.g. as part of UCI in a PUCCH. The SR 792 is enhanced and indicates that the UE 110 wishes to select the MCS to use for the granted uplink data transmission. The NT-TRP 172 transmits control information in the form of an enhanced uplink grant 902. The enhanced uplink grant 902 includes a field 908 allocating a time-frequency resource 584 to be used by the UE 110 to send the uplink data transmission. The enhanced uplink grant 902 may include other fields (not illustrated) granting other resources for the uplink data transmission (e.g. granting transmission power). The grant 902 does not allocate an MCS, which is symbolically shown in FIG. 16 by the presence of “X” at 910. Instead, as shown at 920, the UE selects the MCS to use for the granted uplink data transmission.

Returning to FIG. 15, the enhanced SR response illustrated in that figure is just one example. The contents of the enhanced SR response may be dependent upon what resource(s) the apparatus 372 is autonomously selecting for the granted transmission. For example, if the enhanced SR 792 shown in Example 1 of FIG. 14 is received and it indicates that the apparatus 372 will select the coding rate, but not the modulation, then the enhanced SR response of FIG. 15 needs to indicate the modulation. In general, for every resource that is required for the apparatus 372 to send the data in the granted data transmission, that resource needs to be indicated in the grant (e.g. enhanced SR response) unless the resource is to be selected by the apparatus 372 or is predefined in advance.

In some embodiments, depending upon the implementation, the device 352 may be required to allow the apparatus 372 to autonomously select whatever resource(s) the apparatus 372 requests to select in the SR. In such scenarios, the SR response might not include a field (such as field 906) indicating whether or not the SR response is enhanced. Instead, the grant will be in the format of an enhanced SR response granting only the resources that the apparatus 372 is not selecting. In other embodiments, the device 352 can decide whether or not to accept the enhanced SR and will use the field 906 to indicate to the apparatus 372 whether or not the SR response is enhanced (i.e. whether or not the device 352 accepted that the apparatus 372 will select the resource(s) indicated in the enhanced SR). In some embodiments, the enhanced SR response is longer than a conventional grant. In other embodiments it is shorter, e.g. if it omits bits allocating certain resources. In other embodiments, there are multiple formats for a grant, which might or might not be the same bit length, and the enhanced SR response is one of those formats. In some embodiments, the multiple formats may be multiple DCI formats, and the enhanced SR response may be a DCI having a DCI format without a particular field, e.g. without an MCS field (assuming the at least one resource selected by the apparatus 372 is MCS).

In step 456 of FIG. 8 a flag is transmitted from the device 352 and received by the apparatus 372. The flag indicates that the apparatus 372 is to transmit the data using at least one resource selected by the apparatus 372. The apparatus 372 does not just autonomously select at least one resource without an indication from the device 352, but instead the flag from the device 352 provides the apparatus 372 with permission to proceed. The flag might be explicit, e.g. one or more bit values in control signaling. The flag might instead be implicit, e.g. the receipt of a certain message or message format (e.g. a particular DCI format) acts as the flag. In some embodiments, the flag and the grant are in a same message. The message may, in some embodiments, be DCI or an RRC message or a MAC CE. In some embodiments, the flag is received separately from the grant, e.g. in different messages. For example, the flag may be received in an RRC message or a MAC CE, and the grant may be received in a DCI. As another example, the flag may be received in a first DCI and the grant may be received in a different second DCI. In some embodiments, the flag and the grant are both received in higher-layer signaling, e.g. in RRC signaling or in a MAC CE. A non-exhaustive list of examples of flags are as follows.
A grant having a field of one or more bits that indicates that the apparatus 372 can autonomously select the at least one resource for the data to be transmitted by the apparatus 372 in the granted data transmission. The one or more bits is the flag. The grant may be in higher-layer signaling (e.g. RRC signaling or MAC CE) or in DCI. The field 906 in FIG. 15 may act as the flag, e.g. the flag is the bit value in field 906 indicating that the SR response is enhanced. This is an example of an explicit flag.
A grant having a particular format, e.g. a particular DCI format. The receipt of a grant of that format acts as the flag that the apparatus 372 is to transmit the data using the at least one resource selected by the apparatus 372. For example, if a grant is received having a format in which there is a particular preamble and/or no field for indicating a particular resource (e.g. MCS), then that acts as a flag indicating that the apparatus 372 is to select that resource. This is an example of an implicit flag.
In the two examples above the flag is part of the grant. In another example, the flag can be separate from the grant. For example, the apparatus 372 may transmit a request to the network that requests the apparatus 372 autonomously select a particular resource (e.g. MCS) for future granted transmissions. The device 352, on behalf of the network, may transmit a message indicating that the request has been accepted. The message is the flag. Then, in future grants the apparatus 372 selects the resource. In this example, step 456 of FIG. 8 would actually be two separate transmissions at two separate points in time: the flag is first transmitted, then later a grant is transmitted. The transmission of the flag may be in different signaling from the transmission of the grant (e.g. the flag may be transmitted in RRC signaling and the grant may be transmitted in DCI), or the transmission of the flag and grant may be in the same type of signaling (e.g. both in RRC signaling or both in DCI).
In another example, the flag is implicit and is a certain condition being met. For example, the flag may be at least one of: a channel quality dropping below a certain threshold, a QoS dropping below a certain threshold, a propagation delay exceeding a certain threshold, an error rate exceeding a certain threshold, or a retransmission rate exceeding a certain threshold. In some embodiments, if a parameter indicates that the quality of transmission is poor (e.g. drops below a certain threshold), then this may act as a flag that the apparatus 372 is to autonomously select the at least one resource for a future granted data transmission. For example, the apparatus 372 may select the MCS once two or more retransmissions of the granted data is required.

In some embodiments, the grant transmitted in step 456 of FIG. 8 is a configured grant, e.g. higher-layer signaling (such as RRC signaling) granting resources for data transmissions from the apparatus 372. The resources may then be activated in DCI, e.g. DCI is used to indicate whether the apparatus 372 is to use those granted resources at a particular instance in time. The configured grant might not configure all resources, but instead one or more resources may be autonomously selected by the apparatus 372, e.g. MCS may be selected by the apparatus 372 whenever a data transmission is activated by the DCI. The flag may be explicit in the configured grant (e.g. a field indicating that the apparatus 372 is to select a particular resource) or may be implicit (e.g. a configured grant of a certain format), or the flay may be transmitted by the device 352 and received by the apparatus 372 at a different time, possibly even in the DCI activating the resources.

In some embodiments, the apparatus 372 may select the at least one resource in the manner discussed herein, but there may be a predefined plurality of resources from which the apparatus 372 can select from. For example, the apparatus 372 may autonomously select MCS, but only select from one of 16 different MCS values predefined and known in advance by the apparatus 372 and the device 352. The values may be preconfigured or fixed. Therefore, in some embodiments, the method of FIG. 8 includes the apparatus 372 receiving configuration information (e.g. signaling such as RRC signaling). The configuration information indicates a plurality of resources that may be selected by the apparatus 372. The plurality of resources includes the at least one resource selected by the apparatus 372 in the method of FIG. 8. As an example, the plurality of resource may be a plurality of different MCS values, and the at least one resource selected by the apparatus 372 is one of those MCS values.

In some embodiments, before the method of FIG. 8 is performed there may be an initial access procedure so that the apparatus 372 is in a connected state before step 452. For example, the apparatus 372 may be a UE and the device may be an NT-TRP, such as a satellite. The UE connects with the NT-TRP using an initial access procedure in order to connect with the radio access network. The network may transmit a higher-layer signaling message (e.g. RRC signaling) to the UE, where the message carries basic higher-layer configuration parameters in order for the UE to detect and decode PDCCHs/PDSCHs and transmit PUCCHs/PUSCHs. This may occur prior to step 452. In some embodiments, configuration of one or more parameters of the CI 502 and/or the control channel 702 may occur during or just after initial access. In some embodiments, configuration of BWP 582 described earlier may be performed prior to step 452, e.g. during or just after initial access. The configuration may occur via higher-layer signaling, such as RRC signaling.

In some embodiments, the SR in step 452 of FIG. 8 is transmitted in response to the apparatus 372 having data to transmit that is specifically delay-sensitive, e.g. the data is for transmission on a delay-sensitive logical channel or delay-sensitive logical channel groups, and the transmission is grant-based.

The method of FIG. 8 assumes that the scheduled data transmission transmitted in step 460 is transmitted to the device 352. However, this is not necessary. Instead, the scheduled data transmission may be sent to a different device other than the device 352. As an example, the SR may be a request for the device 352 to schedule a data transmission from apparatus 372 to another device or apparatus, e.g. on uplink, sidelink, or backhaul. For example, the data transmission in step 460 may be from a first UE (apparatus 372) to a second UE.

In some embodiments, the steps performed by the apparatus 372 described above (e.g. in relation to FIG. 8 and its variations) may be performed by the processor 380 of the apparatus 372 executing processor-executable instructions stored in memory (e.g. in memory 382). The instructions, when executed, cause the apparatus 372 to perform the methods. In some embodiments, the apparatus 372 may refer to a one or more circuit chips (e.g. housing processor 380) that cause the apparatus-side methods to be performed, and may exclude the circuitry related to transmitting and receiving (e.g. the antenna, RF chain, etc.).

In some embodiments, the steps performed by the device 352 described above (e.g. in relation to FIG. 8 and its variations) may be performed by the processor 360 of the device 352 executing processor-executable instructions stored in memory (e.g. in memory 362). The instructions, when executed, cause the device 352 to perform the methods. In some embodiments, the device 352 may refer to a one or more circuit chips (e.g. housing processor 360) that cause the network-side methods to be performed, and may exclude the circuitry related to transmitting and receiving (e.g. the antenna, RF chain, etc.).

Many variations of FIG. 8 are described herein, including examples of specific messages, steps, etc. Permutations of all of these variations and examples are contemplated. For example, any of the formats for the grant and/or flag may be combined with any of the SRs (e.g. in FIG. 15), which may be combined with any of the methods of indicating the at least one resource selected by the apparatus (e.g. in FIGS. 9 to 12), etc.

Some embodiments herein may have the following technical benefits: the provision of an enhanced SR, which may allow an apparatus (such as a UE) to request from the network to autonomously select the MCS (and/or other resources); autonomous MCS selection, which may allow the apparatus to autonomously select the modulation and code-rate based on the instantaneous radio conditions the apparatus can sense/measure; use of a flag to indicate to the apparatus that the apparatus is to autonomously select the resource (e.g. MCS).

Although some embodiments herein are described by using an apparatus such as a UE and a device such as a TRP for uplink data transmission, the present invention is also applicable for other scenarios such as sidelink communications. For example, the device may transmit the grant and the flag to the transmitter apparatus of a sidelink for the sidelink data transmission. The device may also transmit the grant and the flag to the receiver apparatus of a sidelink for the sidelink data transmission (alternatively, the transmitter apparatus may forward the grant and the flag to the receiver apparatus). Correspondingly, the transmitter apparatus may select the at least one resource for the sidelink data transmission, which is similar to the method for uplink data transmission. In sidelink embodiments, the CI 502 described earlier may be sidelink control information (SCI) rather than UCI, e.g. it may be SCI sent on a physical sidelink control channel (PSCCH).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method performed by an apparatus, the method comprising:
receiving a flag and a grant, wherein the grant schedules at least a time resource for data, and the flag indicates that the apparatus is to transmit the data using at least one resource selected by the apparatus; and
transmitting the data on the time resource using the at least one resource, wherein the at least one resource comprises at least one of: a modulation, a coding rate, a coding type, a modulation-and-coding scheme (MCS), a frequency resource, a transmit power, a beam, a precoding, or a number of precoding layers.

2. The method of claim 1, further comprising:
selecting the at least one resource based on a channel condition determined by the apparatus.

3. The method of claim 1, further comprising:
transmitting an indication of the at least one resource.

4. The method of claim 3, wherein the indication is transmitted on time-frequency resources scheduled for the data or on a control channel separate from the time-frequency resources scheduled for the data.

5. The method of claim 4, wherein the indication is multiplexed with the data when the indication is transmitted on the time-frequency resources scheduled for the data.

6. An apparatus comprising:
at least one processor coupled with a memory storing processor-executable instructions that, when executed by the at least one processor, cause the apparatus to:
receive a flag and a grant, wherein the grant schedules at least a time resource for data, and the flag indicates that the apparatus is to transmit the data using at least one resource selected by the apparatus; and
transmit the data on the time resource using the at least one resource, wherein the at least one resource comprises at least one of: a modulation, a coding rate, a coding type, a modulation-and-coding scheme (MCS), a frequency resource, a transmit power, a beam, a precoding, or a number of precoding layers.

7. The apparatus of claim 6, wherein the processor-executable instructions, when executed, further cause the apparatus to:
select the at least one resource based on a channel condition determined by the apparatus.

8. The apparatus of claim 6, wherein the processor-executable instructions, when executed, further cause the apparatus to:
transmit an indication of the at least one resource.

9. The apparatus of claim 8, wherein the indication is transmitted on time-frequency resources scheduled for the data or on a control channel separate from the time-frequency resources scheduled for the data.

10. The apparatus of claim 9, wherein the indication is multiplexed with the data when the indication is transmitted on the time-frequency resources scheduled for the data.

11. The apparatus of claim 6, wherein the grant omits a field for indicating the at least one resource.

12. A method comprising:
transmitting, to an apparatus, a flag and a grant, wherein the grant schedules at least a time resource for data, and the flag indicates that the apparatus is to transmit the data using at least one resource selected by the apparatus, the at least one resource comprising at least one of: a modulation, a coding rate, a coding type, a modulation-and-coding scheme (MCS), a frequency resource, a transmit power, a beam, a precoding, or a number of precoding layers; and
receiving the data on the time resource using the at least one resource.

13. The method of claim 12, wherein the at least one resource is to be selected based on a channel condition determined by the apparatus.

14. The method of claim 12, further comprising:
receiving, from the apparatus, an indication of the at least one resource.

15. The method of claim 14, wherein the indication is received on time-frequency resources scheduled for the data or on a control channel separate from the time-frequency resources scheduled for the data.

16. A device comprising:
at least one processor coupled with a memory storing processor-executable instructions that, when executed by the at least one processor, cause the device to:
transmit, to an apparatus, a flag and a grant, wherein the grant schedules at least a time resource for data, and the flag indicates that the apparatus is to transmit the data using at least one resource selected by the apparatus, the at least one resource comprising at least one of: a modulation, a coding rate, a coding type, a modulation-and-coding scheme (MCS), a frequency resource, a transmit power, a beam, a precoding, or a number of precoding layers; and
receive the data on the time resource using the at least one resource.

17. The device of claim 16, wherein the at least one resource is to be selected based on a channel condition determined by the apparatus.

18. The device of claim 16, wherein the processor-executable instructions, when executed, further cause the device to:
receive, from the apparatus, an indication of the at least one resource.

19. The device of claim 18, wherein the indication is received on time-frequency resources scheduled for the data or on a control channel separate from the time-frequency resources scheduled for the data.

20. The device of claim 19, wherein the indication is multiplexed with the data when the indication is received on the time-frequency resources scheduled for the data.
